(19) United States
(12) Patent Application Publication
(10) Pub. No.: US 2009/0062063 A1
(43) Pub. Date: Mar. 5, 2009

(54) VEHICLE, DRIVING SYSTEM, AND CONTROL METHODS THEREOF

(76) Inventors: Akihiro Yamanaka, Aichi-ken (JP); Kensuke Kamichi, Aichi-ken (JP); Hideaki Goda, Aichi-ken (JP); Masaya Yamamoto, Aichi-ken (JP); Yoichi Tajima, Aichi-ken (JP); Takeshi Aoki, Aichi-ken (JP); Kazuomi Okasaka, Aichi-ken (JP)

Correspondence Address: KENYON & KENYON LLP, 1500 K STREET N.W., SUITE 700, WASHINGTON, DC, 20005, US

(21) Appl. No.: 12/282,086

(22) PCT Filed: Mar. 2, 2007
(86) PCT No.: PCT/JP2007/054013

§ 371 Date: Sep. 8, 2008

(30) Foreign Application Priority Data
Mar. 8, 2006 (JP) 2006-063059

(51) Int. Cl. B60W 10/02; B60W 10/06

(52) U.S. Cl. 477/5; 477/3; 903/902

(57) ABSTRACT

At the time of a Hi-to-Lo speed change of a transmission, which is configured to transmit an output torque of a motor to a driveshaft, in an accelerator off state or in a low acceleration state with the driver's slight depression of an accelerator pedal, an engine is controlled to be driven at a rotation speed of not lower than a speed change-time minimum rotation speed that is higher than an idling rotation speed. When the driver depresses the accelerator pedal to require a large torque demand, such drive control enables quick output of a large torque from the engine to a ring gear shaft as the driveshaft.

### TECHNICAL FIELD

The present invention relates to a vehicle, a driving system, and control methods of the vehicle and the driving system.

### BACKGROUND ART

One proposed configuration of a vehicle includes an engine, a planetary gear mechanism constructed to have a carrier connected with a crankshaft of the engine and a ring gear connected with an axle of the vehicle, a first motor generator attached to a sun gear of the planetary gear mechanism, and a second motor generator attached to the axle via a transmission (see, for example, Patent Document 1). The vehicle of this prior art structure is driven with driving force obtained by torque conversion of the output power of the engine in combination with charge and discharge of electric power into and from a battery. The planetary gear mechanism, the first motor generator, and the second motor generator with speed change by the transmission are involved in the torque conversion of the engine output power.

### Patent Document 1: Japanese Patent Laid-Open No. 2002-225578

### DISCLOSURE OF THE INVENTION

In the vehicle of this prior art configuration, in the case of a speed change of the transmission in the state of a small driving force required for driving the vehicle, the transmission is set at a neutral position to decouple the second motor generator from the axle, with a view to reducing a potential torque shock occurring in the course of the speed change of the transmission. The speed change of the transmission is then performed with synchronization of the rotation speed of the second motor generator. The driver may depress an accelerator pedal during the speed change of the transmission in the decoupled state of the second motor generator. The driver's required driving force is, however, not output to the axle, because of no torque output from the second motor generator in the decoupled state. One possible measure drives the first motor generator to increase a fraction of driving force transmitted to the axle via the planetary gear mechanism, out of the output power of the engine. In the state of a small driving force required for driving the vehicle, energy is consumed to increase the rotation speed of the engine. Such energy consumption does not allow quick output of the driver's required driving force.

In the vehicle, the driving system, and the control methods of the vehicle and the driving system, there would thus be a demand for ensuring a quick response to an abrupt change of a driving force demand during a change of a speed of a transmission. In the vehicle, the driving system, and the control methods of the vehicle and the driving system, there would also be a demand for reducing a potential torque shock occurring in the course of changing the speed of the transmission.

The present invention accomplishes at least part of the demand mentioned above and the other relevant demands by the following configurations applied to the vehicle, the driving system, and the control methods of the vehicle and the driving system.

According to one aspect, the invention is directed to a vehicle that includes: an internal combustion engine; an electric power-mechanical power input output structure connected with a first axle as one of axles of the vehicle and with an output shaft of the internal combustion engine and structured to enable power input and power output from and to the first axle and the output shaft accompanied by input and output of electric power and mechanical power; a motor configured to enable power input and power output; a transmission connected with either the first axle or a second axle as a different axle from the first axle and with a rotating shaft of the motor and structured to transmit power between the second axle and the rotating shaft with a speed change between multiple different speeds; an accumulator configured to transmit electric power to and from the electric power-mechanical power input output structure and the motor; a driving force demand setter configured to set a driving force demand required for driving the vehicle; and a controller configured to, in the case of a downshift of the speed of the transmission, controls the internal combustion engine, the electric power-mechanical power input output structure, the motor, and the transmission, so as to downshift the speed of the transmission with keeping the internal combustion engine driven at a rotation speed of not lower than a preset reference level and to drive the vehicle with a driving force equivalent to the driving force demand.

In the case of a downshift of the speed of the transmission, the vehicle according to this aspect of the invention controls the internal combustion engine, the electric power-mechanical power input output structure, the motor, and the transmission, so as to downshift the speed of the transmission with keeping the internal combustion engine driven at the rotation speed of not lower than the preset reference level and to drive the vehicle with the driving force equivalent to the driving force demand required for driving the vehicle. In response to an increase in driving force demand, the electric power-mechanical power input output structure is controlled to lower the rotation speed of the internal combustion engine and thereby enable output of a greater driving force to the first axle. This arrangement of the vehicle ensures a quick response to an increase in driving force demand in the course of a downshift of the speed of the transmission, while effectively reducing a potential torque shock occurring in the course of an upshift of the speed of the transmission.

In one preferable application of the vehicle according to the above aspect of the invention, immediately after an increase in driving force demand during a downshift of the speed of the transmission, the controller controls the internal combustion engine to increase a torque output from the internal combustion engine, while controlling the electric power-mechanical power input output structure to decrease the rotation speed of the internal combustion engine and thereby increase the power output to the first axle. This arrangement ensures output of a large driving force to the first axle, while controlling the decreasing rotation speed of the internal combustion engine.

In another preferable application of the vehicle according to the invention, in the case of a downshift of the speed of the transmission under the condition that the driving force demand is within a preset low driving force range including a value ‘0’, the controller controls the transmission and the motor to downshift the speed of the transmission with disabling output of any torque from the motor to the second axle via the transmission, while controlling the internal combustion engine and the electric power-mechanical power input output structure to drive the vehicle with enabling output of a driving force equivalent to the driving force demand to the first axle via the electric power-mechanical power input output structure. This arrangement effectively reduces a potential torque shock occurring in the course of a downshift of the speed of the transmission. In this case, in response to an abrupt change of the driving force demand during a downshift of the speed of the transmission, the controller may control the transmission and the motor to continue the downshift of the speed of the transmission with disabling output of any torque from the motor to the second axle via the transmission, while controlling the internal combustion engine and the electric power-mechanical power input output structure to drive the vehicle with enabling output of a driving force equivalent to the abruptly increasing driving force demand to the first axle via the electric power-mechanical power input output structure. Further, the transmission may change coupling and decoupling states of multiple clutches to change the speed, and the controller may control the coupling and decoupling states of the multiple clutches to change the speed of the transmission via a state of decoupling the motor from the second axle.

In still another preferable application of the vehicle according to the invention, the electric power-mechanical power input output structure includes: a three shaft-type power input output assembly connected with three shafts, the first axle, the output shaft of the internal combustion engine, and a rotatable third shaft and designed to input and output power to a residual shaft based on powers input from and output to any two shafts among the three shafts; and a generator configured to input and output power from and to the third shaft.

According to another aspect, the invention is directed to a driving system mounted on a vehicle, in combination with an internal combustion engine and a chargeable and dischargeable accumulator. The driving system includes: an electric power-mechanical power input output structure configured to transmit electric power to and from the accumulator, connected with a first axle as one of axles of the vehicle and with an output shaft of the internal combustion engine, and structured to enable power input and power output from and to the first axle and the output shaft accompanied by input and output of electric power and mechanical power; a motor configured to transmit electric power to and from the accumulator and enable power input and power output; a transmission connected with either the first axle or a second axle as a different axle from the first axle and with a rotating shaft of the motor and structured to transmit power between the second axle and the rotating shaft with a speed change between multiple different speeds; and a controller configured to, in the case of a downshift of the speed of the transmission, controls the internal combustion engine, the electric power-mechanical power input output structure, the motor, and the transmission, so as to downshift the speed of the transmission with keeping the internal combustion engine driven at a rotation speed of not lower than a preset reference level and to drive the vehicle with a driving force equivalent to a driving force demand required for driving the vehicle.

In the case of a downshift of the speed of the transmission, the driving system according to the above aspect of the invention controls the internal combustion engine, the electric power-mechanical power input output structure, the motor, and the transmission, so as to downshift the speed of the transmission with keeping the internal combustion engine driven at the rotation speed of not lower than the preset reference level and to drive the vehicle with the driving force equivalent to the driving force demand required for driving the vehicle. In response to an increase in driving force demand, the electric power-mechanical power input output structure is controlled to lower the rotation speed of the internal combustion engine and thereby enable output of a greater driving force to the first axle. This arrangement ensures a quick response to an increase in driving force demand in the course of a downshift of the speed of the transmission, while effectively reducing a potential torque shock occurring in the course of an upshift of the speed of the transmission.

According to still another aspect, the invention is directed to a control method of a vehicle that includes: an internal combustion engine; an electric power-mechanical power input output structure connected with a first axle as one of axles of the vehicle and with an output shaft of the internal combustion engine and structured to enable power input and power output from and to the first axle and the output shaft accompanied by input and output of electric power and mechanical power; a motor configured to enable power input and power output; a transmission connected with either the first axle or a second axle as a different axle from the first axle and with a rotating shaft of the motor and structured to transmit power between the second axle and the rotating shaft with a speed change between multiple different speeds; and an accumulator configured to transmit electric power to and from the electric power-mechanical power input output structure and the motor. In the case of a downshift of the speed of the transmission, the control method controls the internal combustion engine, the electric power-mechanical power input output structure, the motor, and the transmission, so as to downshift the speed of the transmission with keeping the internal combustion engine driven at a rotation speed of not lower than a preset reference level and to drive the vehicle with a driving force equivalent to a driving force demand required for driving the vehicle.

In the case of a downshift of the speed of the transmission, the control method of the vehicle according to this aspect of the invention controls the internal combustion engine, the electric power-mechanical power input output structure, the motor, and the transmission, so as to downshift the speed of the transmission with keeping the internal combustion engine driven at the rotation speed of not lower than the preset reference level and to drive the vehicle with the driving force equivalent to the driving force demand required for driving the vehicle. In response to an increase in driving force demand, the electric power-mechanical power input output structure is controlled to lower the rotation speed of the internal combustion engine and thereby enable output of a greater driving force to the first axle. This arrangement ensures a quick response to an increase in driving force demand in the course of a downshift of the speed of the transmission, while effectively reducing a potential torque shock occurring in the course of an upshift of the speed of the transmission.

According to still another aspect, the invention is directed to a control method of a driving system being mounted on a vehicle in combination with an internal combustion engine and a chargeable and dischargeable accumulator and including: an electric power-mechanical power input output structure configured to transmit electric power to and from the accumulator, connected with a first axle as one of axles of the vehicle and with an output shaft of the internal combustion engine, and structured to enable power input and power output from and to the first axle and the output shaft accompanied by input and output of electric power and mechanical power; a motor configured to transmit electric power to and from the accumulator and enable power input and power output; and a transmission connected with either the first axle or a second axle as a different axle from the first axle and with a rotating shaft of the motor and structured to transmit power between the second axle and the rotating shaft with a speed change between multiple different speeds. In the case of a downshift of the speed of the transmission, the control method controls the internal combustion engine, the electric power-mechanical power input output structure, the motor, and the transmission, so as to downshift the speed of the transmission with keeping the internal combustion engine driven at a rotation speed of not lower than a preset reference level and to drive the vehicle with a driving force equivalent to a driving force demand required for driving the vehicle.

In the case of a downshift of the speed of the transmission, the control method of the driving system according to this aspect of the invention controls the internal combustion engine, the electric power-mechanical power input output structure, the motor, and the transmission, so as to downshift the speed of the transmission with keeping the internal combustion engine driven at the rotation speed of not lower than the preset reference level and to drive the vehicle with the driving force equivalent to the driving force demand required for driving the vehicle. In response to an increase in driving force demand, the electric power-mechanical power input output structure is controlled to lower the rotation speed of the internal combustion engine and thereby enable output of a greater driving force to the first axle. This arrangement ensures a quick response to an increase in driving force demand in the course of a downshift of the speed of the transmission, while effectively reducing a potential torque shock occurring in the course of an upshift of the speed of the transmission.

### BRIEF DESCRIPTION OF THE DRAWINGS

FIG. 1 schematically illustrates the configuration of a hybrid vehicle 20 equipped with a driving system in one embodiment of the invention;

FIG. 2 shows the structure of a transmission 60;

FIG. 3 is a flowchart showing a low driving force, Hi-to-Lo speed change drive control routine executed by a hybrid electronic control unit 70 in the embodiment;

FIG. 4 is a flowchart showing a speed change routine;

FIG. 5 shows one example of a speed change map;

FIG. 6 is an alignment chart of the transmission 60 at the time of a Lo-to-Hi speed change and at the time of a Hi-to-Lo speed change;

FIG. 7 shows one example of a hydraulic pressure sequence for the Lo-to-Hi speed change in a hydraulic pressure circuit of controlling the operations of brakes B1 and B2 in the transmission 60;

FIG. 8 shows one example of a hydraulic pressure sequence for the Hi-to-Lo speed change in the hydraulic pressure circuit of controlling the operations of the brakes B1 and B2 in the transmission 60;

FIG. 9 shows one example of a torque demand setting map;

FIG. 10 is an alignment chart showing torque-rotation speed dynamics of rotational elements in a power distribution integration mechanism 30 when a torque demand Tr* is a small drive torque at the time of the Hi-to-Lo speed change;

FIG. 11 is an alignment chart showing a relation of rotation speeds of the rotational elements in the power distribution integration mechanism 30 when a rotation speed Ne of an engine 22 is set equal to a speed change-time minimum rotation speed Nchg and to an idling rotation speed Nidl at the time of the Hi-to-Lo speed change;

FIG. 12 shows an operation curve of ensuring efficient operation of the engine 22 and a process of setting a tentative engine rotation speed Netmp;

FIG. 13 is an alignment chart showing torque-rotation speed dynamics of the rotational elements in the power distribution integration mechanism 30 when the torque demand Tr* is a brake torque for speed reduction at the time of the Hi-to-Lo speed change;

FIG. 14 schematically illustrates the configuration of another hybrid vehicle 120 in one modified example; and

FIG. 15 schematically illustrates the configuration of still another hybrid vehicle 220 in another modified example.

### BEST MODES OF CARRYING OUT THE INVENTION

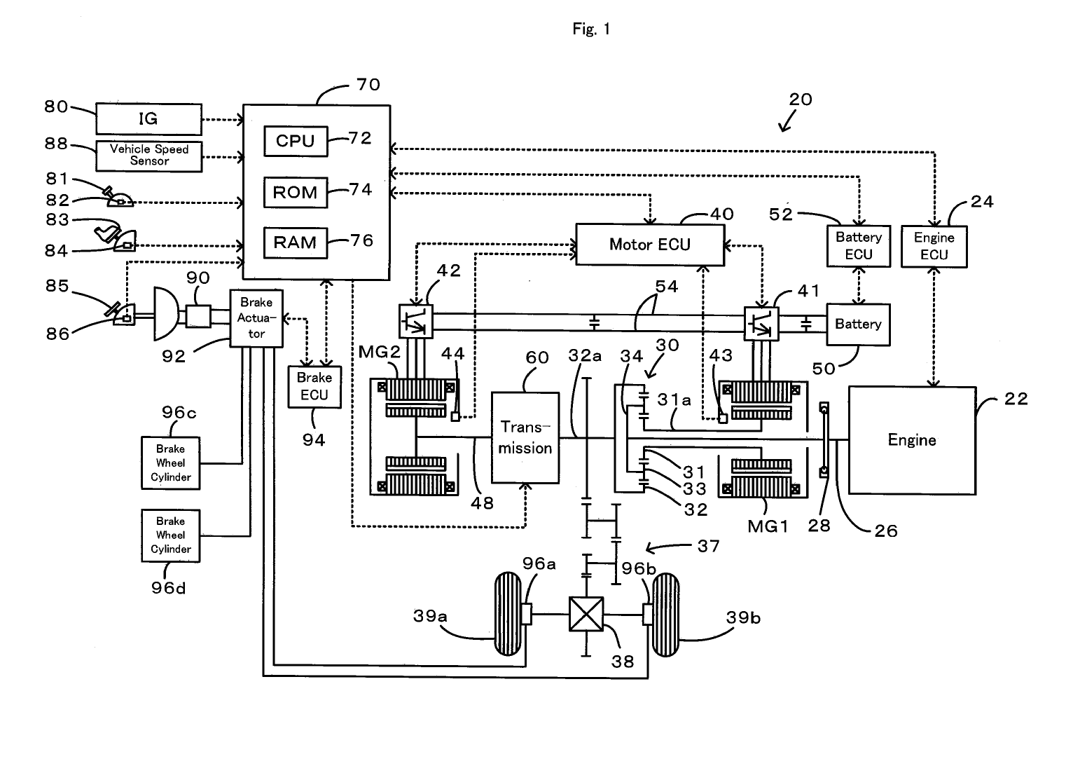

One mode of carrying out the invention is described below as a preferred embodiment with reference to the accompanied drawings. FIG. 1 schematically illustrates the configuration of a hybrid vehicle 20 in one embodiment of the invention. As illustrated, the hybrid vehicle 20 of the embodiment includes an engine 22, a three shaft-type power distribution integration mechanism 30 connected to a crankshaft 26 or an output shaft of the engine 22 via a damper 28, a motor MG1 connected with the power distribution integration mechanism 30 and configured to enable power generation, a motor MG2 connected to the power distribution integration mechanism 30 via a transmission 60, a brake actuator 92 configured to control brakes of drive wheels 39a and 39b and driven wheels (not shown), and a hybrid electronic control unit 70 configured to control the operations of the whole driving system of the hybrid vehicle 20.

The engine 22 is an internal combustion engine that uses a hydrocarbon fuel, such as gasoline or light oil, to output power. An engine electronic control unit (hereafter referred to as engine ECU) 24 receives signals from diverse sensors that detect operating conditions of the engine 22, and takes charge of operation control of the engine 22, for example, fuel injection control, ignition control, and intake air flow regulation. The engine ECU 24 communicates with the hybrid electronic control unit 70 to control operations of the engine 22 in response to control signals transmitted from the hybrid electronic control unit 70 while outputting data relating to the operating conditions of the engine 22 to the hybrid electronic control unit 70 according to the requirements.

The power distribution integration mechanism 30 includes a sun gear 31 as an external gear, a ring gear 32 as an internal gear arranged concentrically with the sun gear 31, multiple pinion gears 33 engaging with the sun gear 31 and with the ring gear 32, and a carrier 34 holding the multiple pinion gears 33 to allow both their revolutions and their rotations on their axes. The power distribution integration mechanism 30 is thus constructed as a planetary gear mechanism including the sun gear 31, the ring gear 32, and the carrier 34 as rotational elements of differential motions. The carrier 34, the sun gear 31, and the ring gear 32 of the power distribution integration mechanism 30 are respectively linked to the crankshaft 26 of the engine 22, to the motor MG1, and to the motor MG2 via the transmission 60. When the motor MG1 functions as a generator, the power of the engine 22 input via the carrier 34 is distributed into the sun gear 31 and the ring gear 32 corresponding to their gear ratio. When the motor MG1 functions as a motor, on the other hand, the power of the engine 22 input via the carrier 34 is integrated with the power of the motor MG1 input via the sun gear 31 and is output to the ring gear 32. The ring gear 32 is mechanically connected to front drive wheels 39a and 39b of the hybrid vehicle 20 via a gear mechanism 37 and a differential gear 38. The power output to the ring gear 32 is thus transmitted to the drive wheels 39a and 39b via the gear mechanism 37 and the differential gear 38. In the driving system of the hybrid vehicle 20, the power distribution integration mechanism 30 is linked to three shafts, that is, the crankshaft 26 or the output shaft of the engine 22 connected with the carrier 34, a sun gear shaft 31a or a rotating shaft of the motor MG1 connected with the sun gear 31, and a ring gear shaft 32a or a driveshaft connected with the ring gear 32 and mechanically linked to the drive wheels 39a and 39b.

The motors MG1 and MG2 are constructed as known synchronous motor generators that may be actuated both as a generator and as a motor. The motors MG1 and MG2 transmit electric powers to and from a battery 50 via inverters 41 and 42. Power lines 54 connecting the battery 50 with the inverters 41 and 42 are structured as common positive bus and negative bus shared by the inverters 41 and 42. Such connection enables electric power generated by one of the motors MG1 and MG2 to be consumed by the other motor MG2 or MG1. Both the motors MG1 and MG2 are driven and controlled by a motor electronic control unit 40 (hereafter referred to as motor ECU 40) The motor ECU 40 inputs signals required for driving and controlling the motors MG1 and MG2, for example, signals representing rotational positions of rotors in the motors MG1 and MG2 from rotational position detection sensors 43 and 44 and signals representing phase currents to be applied to the motors MG1 and MG2 from current sensors (not shown). The motor ECU 40 outputs switching control signals to the inverters 41 and 42. The motor ECU 40 executes a rotation speed computation routine (not shown) to calculate rotation speeds Nm1 and Nm2 of the rotors in the motors MG1 and MG2 from the input signals from the rotational position detection sensors 43 and 44. The motor ECU 40 establishes communication with the hybrid electronic control unit 70 to drive and control the motors MG1 and MG2 in response to control signals received from the hybrid electronic control unit 70 and to output data regarding the operating conditions of the motors MG1 and MG2 to the hybrid electronic control unit 70 according to the requirements.

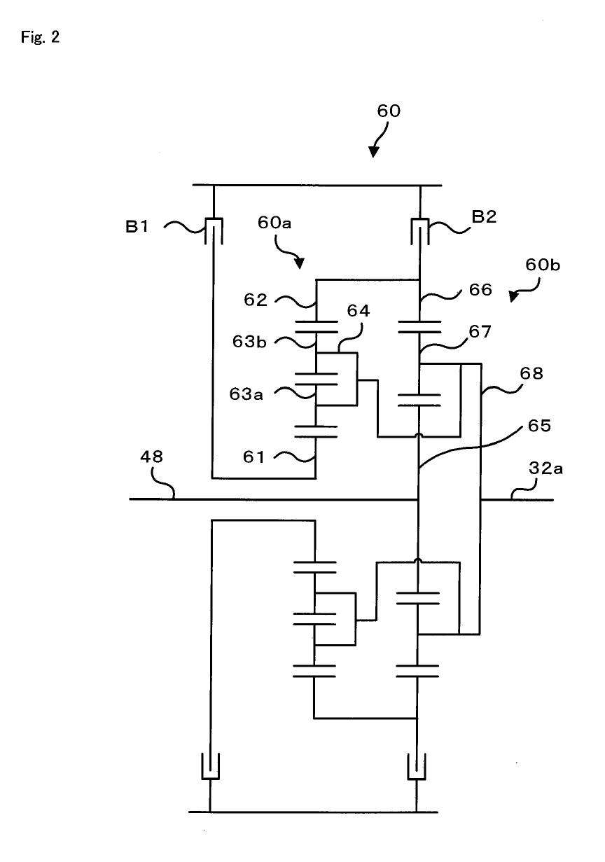

The transmission 60 functions to connect and disconnect a rotating shaft 48 of the motor MG2 with and from the ring gear shaft 32a. In the connection state, the transmission 60 reduces the rotation speed of the rotating shaft 48 of the motor MG2 at two different reduction gear ratios and transmits the reduced rotation speed to the ring gear shaft 32a. One typical structure of the transmission 60 is shown in FIG. 2. The transmission 60 shown in FIG. 2 has a double-pinion planetary gear mechanism 60a, a single-pinion planetary gear mechanism 60b, and two brakes B1 and B2. The double-pinion planetary gear mechanism 60a includes a sun gear 61 as an external gear, a ring gear 62 as an internal gear arranged concentrically with the sun gear 61, multiple first pinion gear 63a engaging with the sun gear 61, multiple second pinion gears 63b engaging with the multiple first pinion gears 63a and with the ring gear 62, and a carrier 64 coupling the multiple first pinion gears 63a with the multiple second pinion gears 63b to allow both their revolutions and their rotations on their axes. The engagement and the release of the brake B1 stop and allow the rotation of the sun gear 61. The single-pinion planetary gear mechanism 60b includes a sun gear 65 as an external gear, a ring gear 66 as an internal gear arranged concentrically with the sun gear 65, multiple pinion gears 67 engaging with the sun gear 65 and with the ring gear 66, and a carrier 68 holding the multiple pinion gears 67 to allow both their revolutions and their rotations on their axes. The sun gear 65 and the carrier 68 of the single-pinion planetary gear mechanism 60b are respectively connected to the rotating shaft 48 of the motor MG2 and to the ring gear shaft 32a. The engagement and the release of the brake B2 stop and allow the rotation of the ring gear 66. The double-pinion planetary gear mechanism 60a and the single-pinion planetary gear mechanism 60b are coupled with each other via linkage of the respective ring gears 62 and 66 and linkage of the respective carriers 64 and 68. In the transmission 60, the combination of the released brakes B1 and B2 disconnects the rotating shaft 48 of the motor MG2 from the ring gear shaft 32a. The combination of the released brake B1 and the engaged brake B2 reduces the rotation of the rotating shaft 48 of the motor MG2 at a relatively large reduction gear ratio and transmits the largely reduced rotation to the ring gear shaft 32a. This state is hereafter expressed as Lo gear position, and the reduction gear ratio in this state is represented by Glo. The combination of the engaged brake B1 and the released brake B2 reduces the rotation of the rotating shaft 48 of the motor MG2 at a relatively small reduction gear ratio and transmits the slightly reduced rotation to the ring gear shaft 32a. This state is hereafter expressed as Hi gear position, and the reduction gear ratio in this state is represented by Ghi. The combination of the engaged brakes B1 and B2 prohibits the rotations of the rotating shaft 48 and the ring gear shaft 32a.

The battery 50 is under control of a battery electronic control unit (hereafter referred to as battery ECU) 52. The battery ECU 52 receives diverse signals required for control of the battery 50, for example, an inter-terminal voltage measured by a voltage sensor (not shown) disposed between terminals of the battery 50, a charge-discharge current measured by a current sensor (not shown) attached to the power line 54 connected with the output terminal of the battery 50, and a battery temperature measured by a temperature sensor (not shown) attached to the battery 50. The battery ECU 52 outputs data relating to the state of the battery 50 to the hybrid electronic control unit 70 via communication according to the requirements. The battery ECU 52 calculates a state of charge (SOC) of the battery 50, based on the accumulated charge-discharge current measured by the current sensor, for control of the battery 50.

The brake actuator 92 regulates the hydraulic pressures of brake wheel cylinders 96a to 96d to enable application of a brake torque to the drive wheels 39a and 39b and to driven wheels (not shown), which satisfies a brake share of a total required braking force for the hybrid vehicle 20 determined according to the vehicle speed V and the pressure of a brake master cylinder 90 (brake pressure) in response to the driver's depression of a brake pedal 85, while regulating the hydraulic pressures of the brake wheel cylinders 96a through 96d to enable application of the brake torque to the drive wheels 39a and 39b and to the driven wheels, independently of the driver's depression of the brake pedal 85. The brake actuator 92 is under control of a brake electronic control unit (hereafter referred to as brake ECU) 94. The brake ECU 94 inputs signals from various sensors through signal lines (not shown), for example, wheel speeds from wheel speed sensors (not shown) attached to the drive wheels 39a and 39b and the driven wheels and a steering angle from a steering angle sensor (not shown). The brake ECU 94 performs antilock braking system (ABS) control for preventing a lock of any of the drive wheels 39a and 39b and the driven wheels from occurring in response to the driver's depression of the brake pedal 85, traction control (TRC) for preventing a slip of either of the drive wheels 39a and 39b from occurring in response to the driver's depression of an accelerator pedal 83, and vehicle stability control (VSC) for keeping the stability of the hybrid vehicle 20 in a turn. The brake ECU 94 establishes communication with the hybrid electronic control unit 70 to drive and control the brake actuator 92 in response to control signals from the hybrid electronic control unit 70 and to output data regarding the operating conditions of the brake actuator 92 to the hybrid electronic control unit 70 according to the requirements.

The hybrid electronic control unit 70 is constructed as a microprocessor including a CPU 72, a ROM 74 that stores processing programs, a RAM 76 that temporarily stores data, input and output ports (not shown), and a communication port (not shown). The hybrid electronic control unit 70 receives, via its input port, an ignition signal from an ignition switch 80, a gearshift position SP or a current setting position of a gearshift lever 81 from a gearshift position sensor 82, an accelerator opening Acc or the driver's depression amount of an accelerator pedal 83 from an accelerator pedal position sensor 84, a brake pedal position BP or the driver's depression amount of a brake pedal 85 from a brake pedal position sensor 86, and a vehicle speed V from a vehicle speed sensor 88. The hybrid electronic control unit 70 outputs, via its output port, driving signals to actuators (not shown) to regulate the brakes B1 and B2 in the transmission 60. The hybrid electronic control unit 70 establishes communication with the engine ECU 24, the motor ECU 40, the battery ECU 52, and the brake ECU 94 via its communication port to receive and send the diversity of control signals and data from and to the engine ECU 24, the motor ECU 40, the battery ECU 52, and the brake ECU 94, as mentioned above.

The hybrid vehicle 20 of the embodiment thus constructed calculates a torque demand to be output to the ring gear shaft 32a functioning as the drive shaft, based on observed values of a vehicle speed V and an accelerator opening Acc, which corresponds to a driver's step-on amount of an accelerator pedal 83. The engine 22 and the motors MG1 and MG2 are subjected to operation control to output a required level of power corresponding to the calculated torque demand to the ring gear shaft 32a. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution integration mechanism 30 and the motors MG1 and MG2 and output to the ring gear shaft 32a. The charge-discharge drive mode controls the operations of the engine 22 to output a quantity of power equivalent to the sum of the required level of power and a quantity of electric power consumed by charging the battery 50 or supplied by discharging the battery 50, while driving and controlling the motors MG1 and MG2 to cause all or part of the power output from the engine 22 equivalent to the required level of power to be subjected to torque conversion by means of the power distribution integration mechanism 30 and the motors MG1 and MG2 and output to the ring gear shaft 32a, simultaneously with charge or discharge of the battery 50. The motor drive mode stops the operations of the engine 22 and drives and controls the motor MG2 to output a quantity of power equivalent to the required level of power to the ring gear shaft 32a.

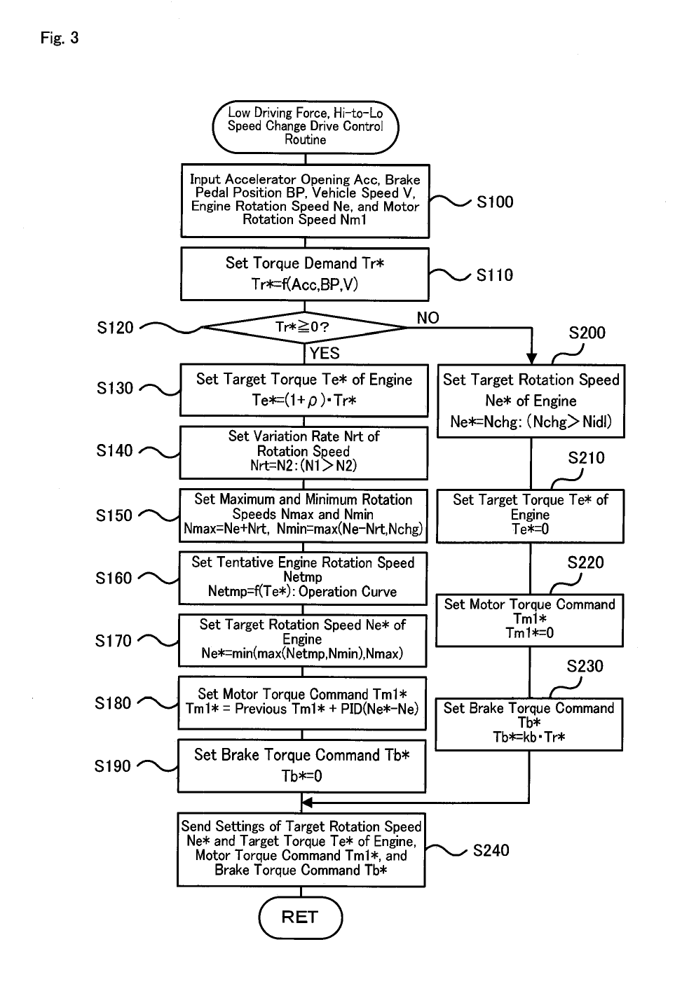

The description regards the operations of the hybrid vehicle 20 of the embodiment, especially a series of operations at the time of a change of the speed of the transmission 60 from the Hi gear position to the Lo gear position during a drive of the hybrid vehicle 20 with a low driving force in an accelerator off state or in a low acceleration state with the driver's slight depression of the accelerator pedal 83. FIG. 3 is a flowchart showing a low driving force, Hi-to-Lo speed change drive control routine, which is executed by the hybrid electronic control unit 70 of the embodiment at the time of a change of the speed of the transmission 60 from the Hi gear position to the Lo gear position in the accelerator off state or in the low acceleration state with the driver's slight depression of the accelerator pedal 83. FIG. 4 is a flowchart showing a speed change routine executed by the hybrid electronic control unit 70 at the time of a change of the speed of the transmission 60. For convenience of explanation, the description first regards the change of the speed of the transmission 60.

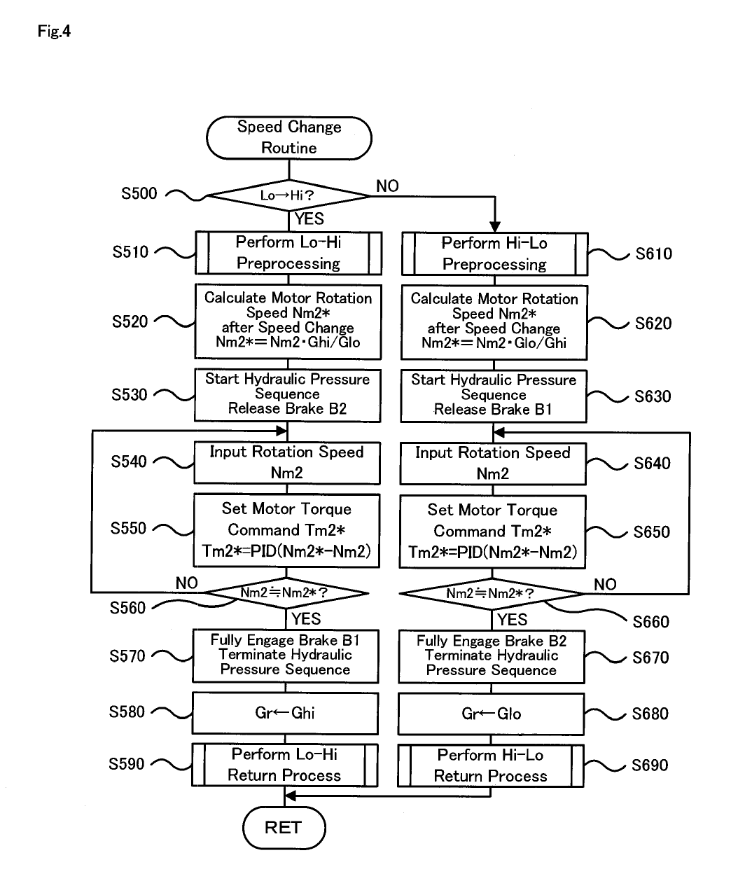

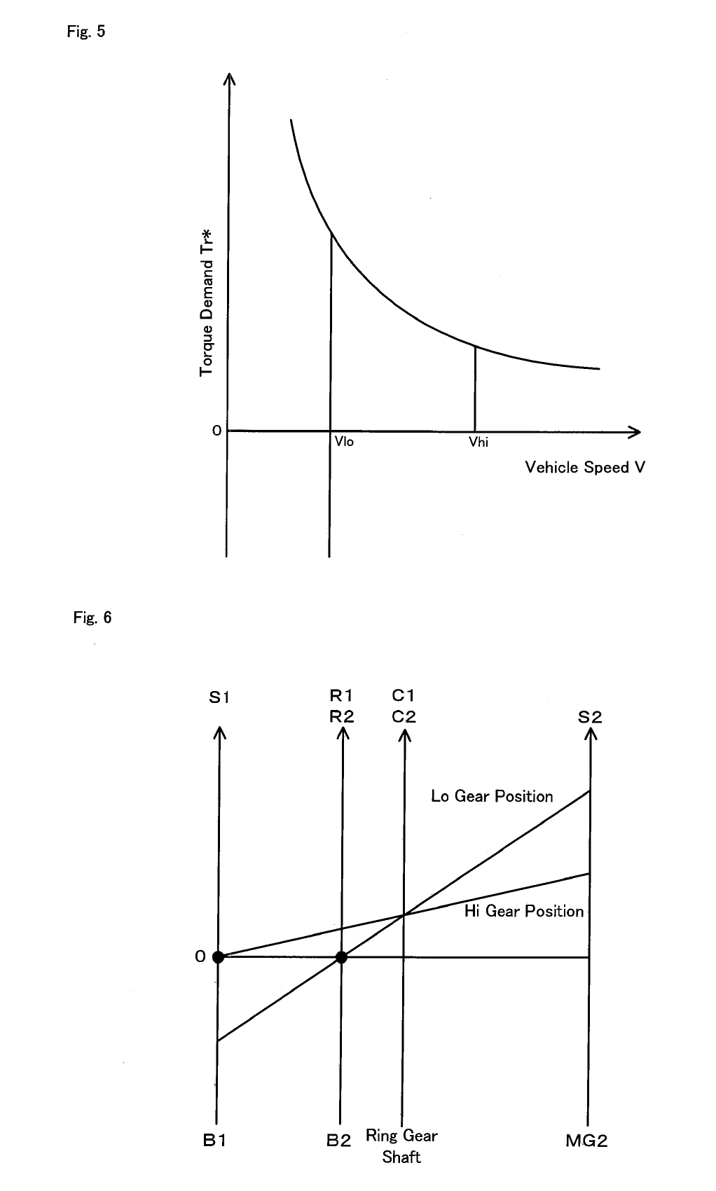

The change of the speed of the transmission 60 is performed on requirement for a Lo-to-Hi speed change or on requirement for a Hi-to-Lo speed change according to a speed change requirement determination process (not shown). The speed change requirement determination process takes into account the vehicle speed V and a torque demand Tr* required for the vehicle and determines whether the Lo-to-Hi speed change is required to change the speed from the Lo gear position to the Hi gear position or whether the Hi-to-Lo speed change is required to change the speed from the Hi gear position to the Lo gear position. FIG. 5 shows one example of a speed change map referred to for the change of the speed in the transmission 60. In the illustrated speed change map of FIG. 5, when the vehicle speed V increases over a Lo-Hi speed change line Vhi, the speed of the transmission 60 set at the Lo gear position is changed from the Lo gear position to the Hi gear position. When the vehicle speed V decreases below a Hi-Lo speed change line Vlo, the speed of the transmission 60 set at the Hi gear position is changed from the Hi gear position to the Lo gear position. In the accelerator off state, the Lo-to-Hi speed change is performed when the vehicle speed V of the vehicle running on a downhill increases over the Lo-Hi speed change line Vhi.

In the speed change routine of FIG. 4, the CPU 72 of the hybrid electronic control unit 70 first identifies whether the required change of the speed in the transmission 60 is the Lo-to-Hi speed change to change the speed from the Lo gear position to the Hi gear position or the Hi-to-Lo speed change to change the speed from the Hi gear position to the Lo gear position (step S500). The identification of the speed change is based on the determination whether the vehicle speed V increases over the Lo-Hi speed change line Vhi or decreases below the Hi-Lo speed change line Vlo in the speed change map of FIG. 5.

Upon identification of the Lo-to-Hi speed change at step S500, Lo-Hi preprocessing is performed (step S510). The Lo-Hi preprocessing sets an output torque of the motor MG2 to 0, with a view to preventing a potential torque shock at the time of a speed change. In the state of output of a drive torque from the motor MG2, the Lo-Hi preprocessing replaces the drive torque output from the motor MG2 with a drive torque from the engine 22 and the motor MG1. In the state of output of a brake torque from the motor MG2, on the other hand, the Lo-Hi preprocessing replaces the brake torque output from the motor MG2 with a brake torque applied by the brake wheel cylinders 96a to 96d to the drive wheels 39a and 39b and to the driven wheels. After the Lo-Hi preprocessing, the CPU 72 calculates an expected rotation speed Nm2* of the motor MG2 after the speed change from the Lo gear position to the Hi gear position from a current rotation speed Nm2 of the motor MG2 and a gear ratio Glo at the Lo gear position and a gear ratio Ghi at the Hi gear position of the transmission 60 according to Equation (1) given below (step S520):

Nm2*=Nm2·Ghi/Glo (1)

The CPU 72 subsequently starts a hydraulic pressure sequence on a hydraulically driven actuator (not shown) for the transmission 60 to release the brake B2 and engage the brake B1 in the transmission 60 (step S530). Until the rotation speed Nm2 of the motor MG2 sufficiently approaches to the expected rotation speed Nm2* after the speed change, the CPU 72 repeats a series of operations to input the rotation speed Nm2 of the motor MG2, set a torque command Tm2* of the motor MG2 according to Equation (2) given below to rotate the motor MG2 at the expected rotation speed Nm2* after the speed change, and send the set torque command Tm2* to the motor ECU 40 (steps S540 to S560):

Tm2*=k1(Nm2*−Nm2)+k2∫(Nm2*−Nm2)dt (2)

The rotation speed Nm2 of the motor MG2 is computed from the rotational position of the rotor in the motor MG2 detected by the rotational position detection sensor 44 and is input from the motor ECU 40 by communication. Equation (2) is a relational expression of feedback control to make the rotation speed of the motor MG2 approach to the expected rotation speed Nm2* after the speed change. In Equation (2), a coefficient k1 in a first term on the right side and a coefficient k2 in a second term on the right side respectively denote a gain of a proportional and a gain of an integral term. In response to reception of the set torque command Tm2* of the motor MG2, the motor ECU 40 performs switching control of switching elements included in the inverter 42 to make the motor MG2 output a torque equivalent to the set torque command Tm2*.

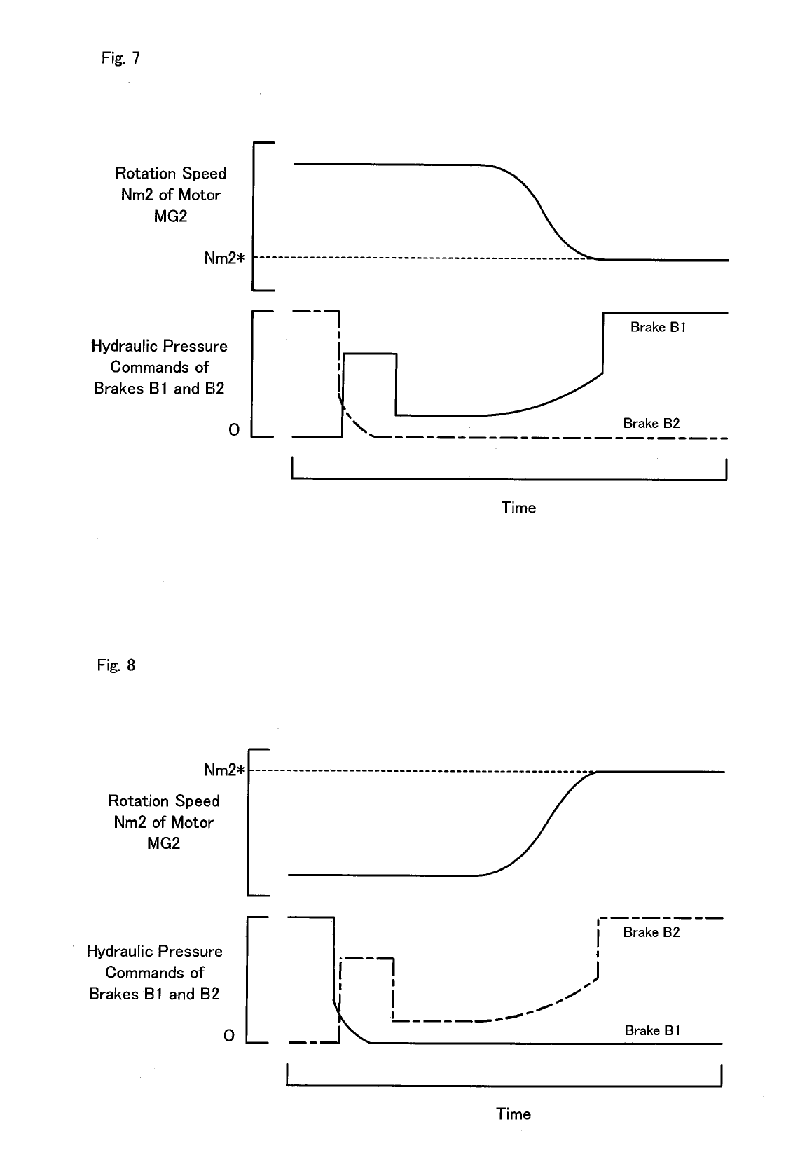

When the rotation speed Nm2 of the motor MG2 sufficiently approaches to the expected rotation speed Nm2* after the speed change, the CPU 72 fully engages the brake B1 and terminates the hydraulic pressure sequence (step S570), and sets the gear ratio Ghi at the Hi gear position to a gear ratio Gr of the transmission 60, which will be used in drive control (step S580) The CPU 72 then performs Lo-Hi return process, which is reverse to the Lo-Hi preprocessing (step S590) and terminates the speed change routine. FIG. 6 is an alignment chart of the transmission 60 at the time of a Lo-to-Hi speed change and at the time of a Hi-to-Lo speed change. FIG. 7 shows one example of the hydraulic pressure sequence for the Lo-to-Hi speed change. In the alignment chart of FIG. 6, an S1-axis shows a rotation speed of the sun gear 61 in the double-pinion planetary gear mechanism 60a. An R1, R2-axis shows a rotation speed of the ring gear 62 in the double-pinion planetary gear mechanism 60a and of the ring gear 66 in the single-pinion planetary gear mechanism 60b. A C1, C2-axis shows a rotation speed of the carrier 64 in the double-pinion planetary gear mechanism 60a and of the carrier 68 in the single-pinion planetary gear mechanism 60b, which is equivalent to the rotation speed of the ring gear shaft 32a. An S2-axis shows a rotation speed of the sun gear 65 in the single-pinion planetary gear mechanism 60b, which is equivalent to the rotation speed of the motor MG2. As illustrated, at the Lo gear position, the brake B2 is engaged, while the brake B1 is released. Release of the brake B2 at this Lo gear position causes the motor MG2 to be decoupled from the ring gear shaft 32a. In this state, the motor MG2 is controlled to be rotated at the expected rotation speed Nm2* after the speed change. On condition that the rotation speed Nm2 of the motor MG2 reaches the expected rotation speed Nm2* after the speed change, the brake B1 is engaged to attain the Lo-to-Hi speed change without torque output from the transmission 60 to the ring gear shaft 32a as the driveshaft. The Lo-to-Hi speed change performed with synchronization of the rotation speed of the motor MG2 effectively prevents a potential torque shock from occurring in the course of a speed change. As shown in FIG. 7, the brake B1 has a significant increase in hydraulic pressure command immediately after the start of the hydraulic pressure sequence. This is ascribed to a fast fill of oil into the cylinder prior to application of an engagement force to the brake B1.

Upon identification of the Hi-to-Lo speed change at step S500, Hi-Lo preprocessing is performed (step S610). The Hi-Lo preprocessing sets the output torque of the motor MG2 to 0, with a view to preventing a potential torque shock from occurring at the time of a speed change. In the state of output of a drive torque from the motor MG2, the Hi-Lo preprocessing replaces the drive torque output from the motor MG2 with a drive torque from the engine 22 and the motor MG1. In the state of output of a brake torque from the motor MG2, on the other hand, the Hi-Lo preprocessing replaces the brake torque output from the motor MG2 with a brake torque applied by the brake wheel cylinders 96a to 96d to the drive wheels 39a and 39b and to the driven wheels. After the Hi-Lo preprocessing, the CPU 72 calculates an expected rotation speed Nm2* of the motor MG2 after the speed change from the Hi gear position to the Lo gear position from the current rotation speed Nm2 of the motor MG2 and the gear ratio Glo at the Lo gear position and the gear ratio Ghi at the Hi gear position of the transmission 60 according to Equation (3) given below (step S620):

Nm2*=Nm2·Glo/Ghi (3)

The CPU 72 subsequently starts a hydraulic pressure sequence on the hydraulically driven actuator for the transmission 60 to release the brake B1 and engage the brake B2 in the transmission 60 (step S630). Until the rotation speed Nm2 of the motor MG2 sufficiently approaches to the expected rotation speed Nm2* after the speed change, the CPU 72 repeats the series of operations to input the rotation speed Nm2 of the motor MG2, set the torque command Tm2* of the motor MG2 according to Equation (2) given above to rotate the motor MG2 at the expected rotation speed Nm2* after the speed change, and send the set torque command Tm2* to the motor ECU 40 (steps S640 to S660).

When the rotation speed Nm2 of the motor MG2 sufficiently approaches to the expected rotation speed Nm2* after the speed change, the CPU 72 fully engages the brake B2 and terminates the hydraulic pressure sequence (step S670), and sets the gear ratio Glo at the Lo gear position to the gear ratio Gr of the transmission 60, which will be used in drive control (step S680) The CPU 72 then performs Hi-Lo return process, which is reverse to the Hi-Lo preprocessing (step S690) and terminates the speed change routine. FIG. 8 shows one example of the hydraulic pressure sequence for the Hi-to-Lo speed change to change the speed of the transmission 60 from the Hi gear position to the Lo gear position. As shown in FIG. 8, the brake B2 has a significant increase in hydraulic pressure command immediately after the start of the hydraulic pressure sequence. This is ascribed to a fast fill of oil into the cylinder prior to application of an engagement force to the brake B2.

The description now regards the drive control at the time of the Hi-to-Lo speed change of the transmission 60 in the low driving force state. In the low driving force, Hi-to-Lo speed change drive control routine of FIG. 3, the CPU 72 of the hybrid electronic control unit 70 first inputs various data required for control, that is, the accelerator opening Acc from the accelerator pedal position sensor 84, the brake pedal position BP from the brake pedal position sensor 86, the vehicle speed V from the vehicle speed sensor 88, a rotation speed Ne of the engine 22, and a rotation speed Nm1 of the motor MG1 (step S100). The rotation speed Ne of the engine 22 is computed from a signal from a crank position sensor (not shown) attached to the crankshaft 26 and is input from the engine ECU 24 by communication. The rotation speeds Nm1 and Nm2 of the motors MG1 and MG2 are computed from the rotational positions of the respective rotors in the motors MG1 and MG2 detected by the rotational position detection sensors 43 and 44 and are input from the motor ECU 40 by communication.

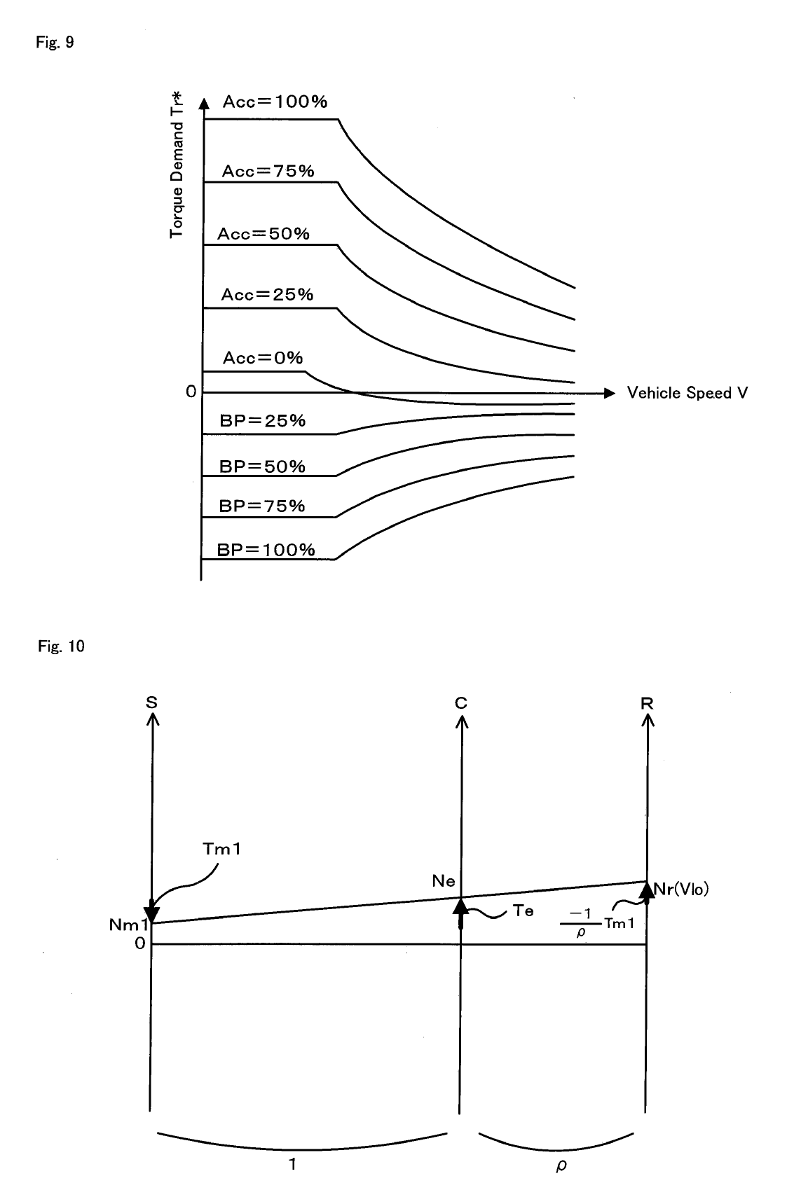

After the data input, the CPU 72 sets a torque demand Tr* to be output to the ring gear shaft 32a or the driveshaft liked with the drive wheels 39a and 39b as a torque required for the hybrid vehicle 20, based on the input accelerator opening Acc, the input brake pedal position BP, and the input vehicle speed V (step S110), and determines whether the set torque demand Tr* is not less than 0 to identify the set torque demand Tr* as a drive torque for acceleration or a brake torque for speed reduction (step S120). A concrete procedure of setting the torque demand Tr* in this embodiment stores in advance variations in torque demand Tr* against the vehicle speed V with regard to various settings of the accelerator opening Acc or the brake pedal position BP as a torque demand setting map in the ROM 74 and reads the torque demand Tr* corresponding to the given accelerator opening Acc or the given brake pedal position BP and the given vehicle speed V from this torque demand setting map. One example of the torque demand setting map is shown in FIG. 9. The torque demand Tr* is identified as the drive torque for acceleration or as the brake torque for speed reduction, because no power output from the engine 22 is basically required in the state of output of a brake torque for speed reduction. Even in the state of output of a drive torque for acceleration, the vehicle is decelerated when the drive torque for acceleration is smaller than a driving resistance of the vehicle. Only the sign of the torque demand Tr* is thus not sufficient for identification between acceleration and speed reduction of the vehicle.

When the torque demand Tr* is not less than 0, a target torque Te* of the engine 22 is set according to Equation (4) using a gear ratio ρ of the power distribution integration mechanism 30, in order to enable the output torque of the engine 22 to be applied as the torque demand Tr* to the ring gear shaft 32a via the power distribution integration mechanism 30 (step S130):

Te*=(1+ρ)·Tr* (4)

FIG. 10 is an alignment chart showing torque-rotation speed dynamics of the rotational elements in the power distribution integration mechanism 30 when the torque demand Tr* is a small drive torque at the time of the Hi-to-Lo speed change. In the alignment chart of FIG. 10, an S-axis shows a rotation speed of the sun gear 31, which is equivalent to the rotation speed Nm1 of the motor MG1. A C-axis shows a rotation speed of the carrier 34, which is equivalent to the rotation speed Ne of the engine 22. An R-axis shows a rotation speed Nr of the ring gear 32 obtained by multiplying the rotation speed Nm2 of the motor MG2 by the gear ratio Gr of the transmission 60. A thick arrow on the R-axis represents a torque applied to the ring gear shaft 32a via the power distribution integration mechanism 30 by torque output from the motor MG1 or a torque applied to the ring gear shaft 32a via the power distribution integration mechanism 30 by torque output from the engine 22. Equation (4) is readily introduced from the alignment chart of FIG. 10.

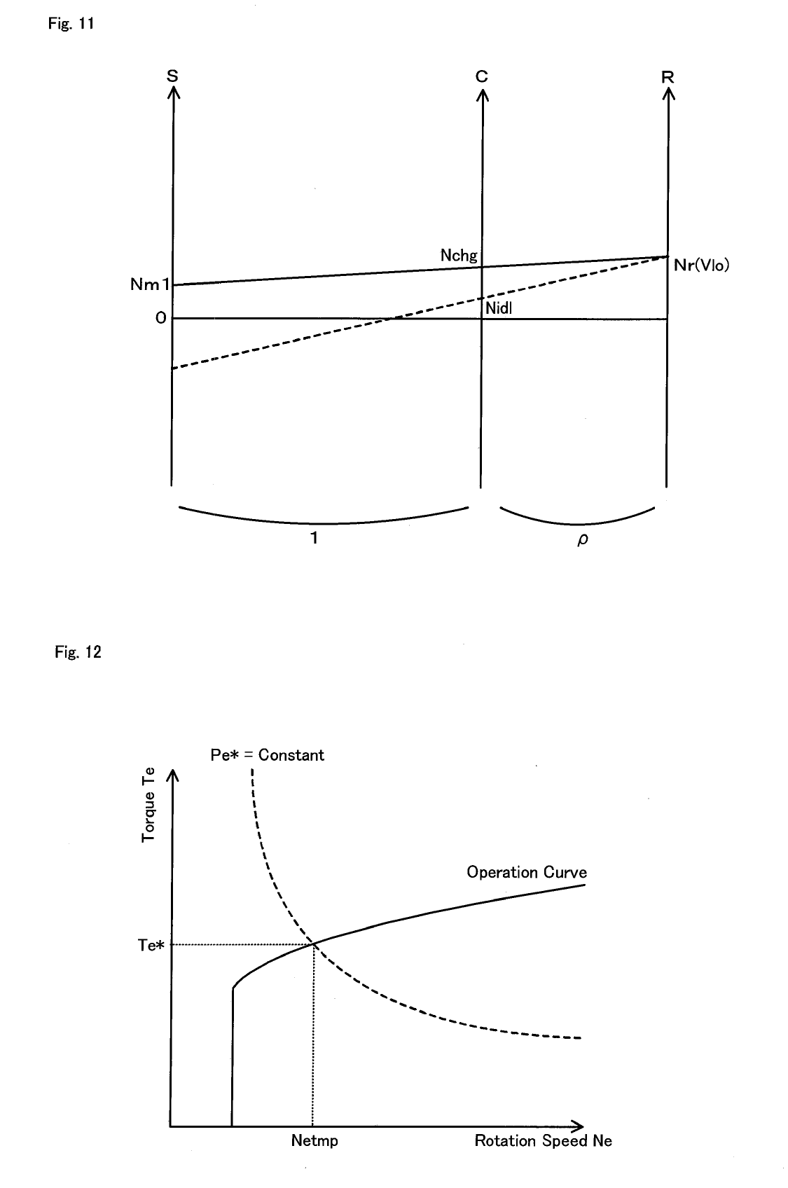

A smaller rate value N2, which is smaller than an ordinary rate value N1 under the condition of no speed change of the transmission 60, is set to a variation rate Nrt of the rotation speed of the engine 22 (step S140). The CPU 72 adds the variation rate Nrt to the rotation speed Ne of the engine 22 to set a maximum rotation speed Nmax, while selecting the greater between a result of subtraction of the variation rate Nrt from the rotation speed Ne of the engine 22 and a speed change-time minimum rotation speed Nchg set to be higher than an idling rotation speed Nidl, to set a minimum rotation speed Nmin (step S150). The maximum rotation speed Nmax is set by using the smaller rate value N2 than the ordinary rate value N1 under the condition of no speed change of the transmission 60 as mentioned above. Such setting restricts the increase in rotation speed of the engine 22 and increases a fraction of power output to the ring gear shaft 32 out of the whole output power of the engine 22 when the driver depresses the accelerator pedal 83 to require a large torque demand Tr* or a large power. The minimum rotation speed Nmin is set to be not lower than the speed change-time minimum rotation speed Nchg that is higher than the idling rotation speed Nidl. Such setting ensures quicker output of a large power from the engine 22 and reduces input and output of electric power to and from the motor MG1 when the driver depresses the accelerator pedal 83 to require a large torque demand Tr* or a large power. FIG. 11 is an alignment chart showing a relation of rotation speeds of the rotational elements in the power distribution integration mechanism 30 when the rotation speed Ne of an engine 22 is set equal to the speed change-time minimum rotation speed Nchg and to the idling rotation speed Nidl at the time of the Hi-to-Lo speed change. A solid line curve represents a collinear relation when the rotation speed Ne of the engine 22 is set equal to the speed change-time minimum rotation speed Nchg. A broken line curve represents a collinear relation when the rotation speed Ne of the engine 22 is set equal to the idling rotation speed Nidl.

A tentative engine rotation speed Netmp is subsequently set, based on the set target torque Te* of the engine 22 and an operation curve of ensuring efficient operation of the engine 22 (step S160). A target rotation speed Ne* of the engine 22 is set by restricting the tentative engine rotation speed Netmp with the maximum rotation speed Nmax and the minimum rotation speed Nmin (step S170). FIG. 12 shows an operation curve of ensuring efficient operation of the engine 22 and a process of setting the tentative engine rotation speed Netmp. A torque command Tm1* of the motor MG1 is set according to Equation (5) given below to rotate the engine 22 at the target rotation speed Ne* (step S180):

Tm1*=previous Tm1*+k3(Ne*−Ne)+k4∫(Ne*−Ne)dt (5)

A brake torque command Tb* is then set equal to 0 (step S190). The hydraulic pressures of the brake wheel cylinders 96a to 96b are regulated according to the setting of the brake torque command Tb*, so as to ensure application of a brake torque to the drive wheels 39a and 39b and to the driven wheels (not shown). The CPU 72 sends the settings of the target rotation speed Ne* and the target torque Te* of the engine 22 to the engine ECU 24, the setting of the torque command Tm1* of the motor MG1 to the motor ECU 40, and the setting of the brake torque command Tb* to the brake ECU 94 (step S240). The low driving force, Hi-to-Lo speed change drive control routine is then terminated. Equation (5) is a relational expression of feedback control to rotate the engine 22 at the target rotation speed Ne*. In Equation (5), a coefficient ‘k3’ in a second term on the right side and a coefficient ‘k4’ in a third term on the right side respectively denote a gain of a proportional and a gain of an integral term. The engine ECU 24 receives the settings of the target rotation speed Ne* and the target torque Te* and controls the intake air flow, fuel injection, and ignition to drive the engine 22 at a drive point defined by the target rotation speed Ne* and the target torque Te*. The motor ECU 40 receives the setting of the torque command Tm1* and performs switching control of the switching elements included in the inverter 41 to make the motor MG1 output a torque equivalent to the torque command Tm1*. The brake ECU 94 receives the brake torque command Tb* set to 0 and controls the operation of the brake actuator 92 to prohibit application of any braking force to the drive wheels 39a and 39b and to the driven wheels.

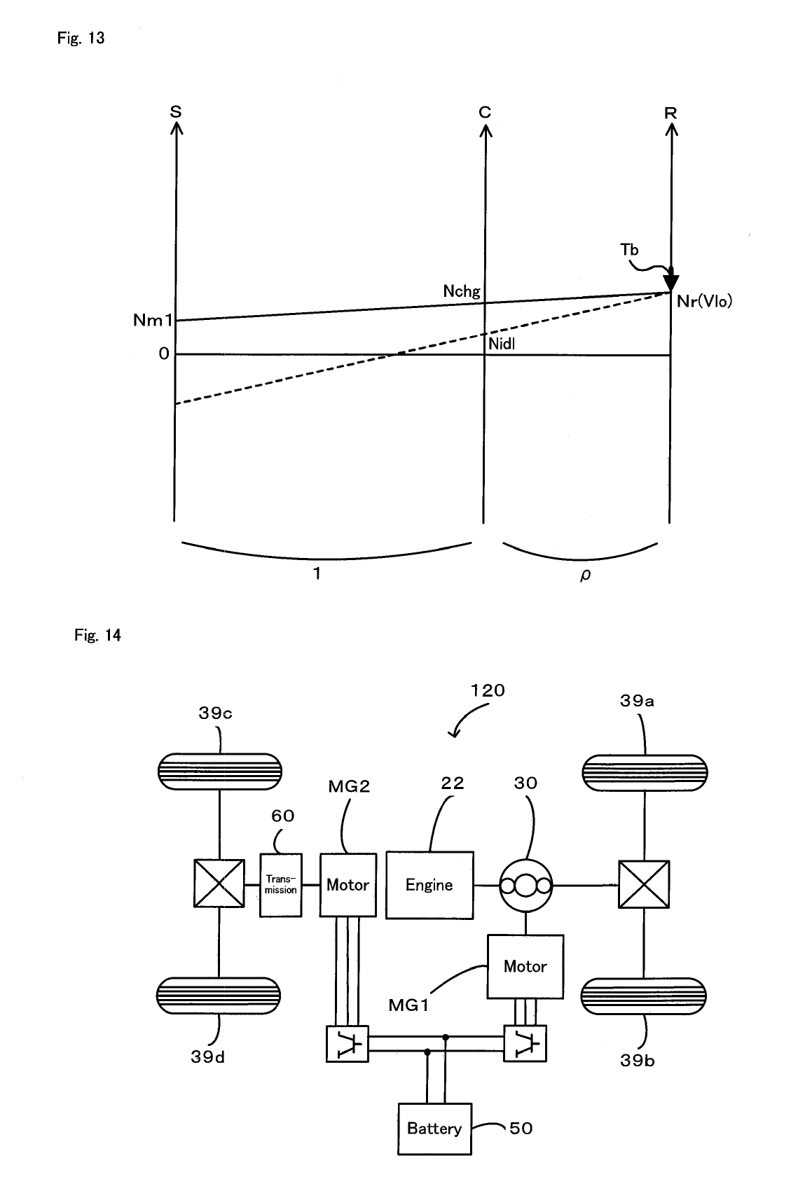

Upon identification of the torque demand Tr* as a brake torque for speed reduction at step S120, the CPU 72 sets the speed change-time minimum rotation speed Nchg that is higher than the idling rotation speed Nidl of the engine 22 to the target rotation speed Ne* of the engine 22 (step S200), sets both the target torque Te* of the engine 22 and the torque command Tm1* of the motor MG1 to 0 (steps S210 and S220), and sets the brake torque command Tb* to enable application of a braking force to the drive wheels 39a and 39b and to the driven wheels in the state of application of the torque demand Tr* as the brake torque to the ring gear shaft 32a (step S230). The CPU 72 sends the settings of the target rotation speed Ne* and the target torque Te* of the engine 22 to the engine ECU 24, the setting of the torque command Tm1* of the motor MG1 to the motor ECU 40, and the setting of the brake torque command Tb* to the brake ECU 94 (step S240). The low driving force, Hi-to-Lo speed change drive control routine is then terminated. When the torque demand Tr* is identified as a brake torque for speed reduction, the speed change-time minimum rotation speed Nchg higher than the idling rotation speed Nidl is set to the target rotation speed Ne* of the engine 22 as mentioned above. Such setting ensures quicker output of a large power from the engine 22 when the driver subsequently depresses the accelerator pedal 83 to require a large torque demand Tr* or a large power. FIG. 13 is an alignment chart showing torque-rotation speed dynamics of the rotational elements in the power distribution integration mechanism 30 when the torque demand Tr* is a brake torque for speed reduction at the time of the Hi-to-Lo speed change. A thick arrow on an R-axis represents a torque applied to the ring gear shaft 32a, which corresponds to a brake torque by the hydraulic brake.

It is assumed that the driver depresses the accelerator pedal 83 during a Hi-to-Lo speed change of the transmission 60 in the accelerator off state or in the low acceleration state with the driver's slight depression of the accelerator pedal 83 (in the state of driving with a low driving force). Immediately before the driver's depression of the accelerator pedal 83, when the torque demand Tr* is a drive torque for acceleration, the processing of steps S130 to S190 is performed in the drive control routine of FIG. 3. In the stationary state, the engine 22 and the motor MG1 are thus controlled to respectively output torques equivalent to the target torque Te* and the torque command Tm1* with a view to ensuring application of the torque demand Tr* to the ring gear shaft 32a. When the torque demand Tr* is a brake torque for speed reduction, on the other hand, the processing of steps S200 to S230 is performed to enable self-sustained operation of the engine 22 at the speed change-time minimum rotation speed Nchg and to output a braking force equivalent to the torque demand Tr* to the drive wheels 39a and 39b and to the driven wheels by the hydraulic brakes of the brake wheel cylinders 96a to 96d. In response to the driver's depression of the accelerator pedal 83, the accelerator opening Acc is increased according to the depression of the accelerator pedal 83 to set a large value to the torque demand Tr*. The engine 22 driven at the rotation speed of not lower than the speed change-time minimum rotation speed Nchg (steps S150 and S200) enables quicker output of a large torque and a large power, compared with the engine 22 driven at the idling rotation speed Nidl. This ensures quicker output of a large power to the ring gear shaft 32a or the driveshaft. In response to setting a large value to the torque demand Tr* by the driver's depression of the accelerator pedal 83, large values are set to the target torque Te* of the engine 22 and the tentative engine rotation speed Netmp (steps S130 and S160). The tentative engine rotation speed Netmp is restricted by the upper rotation speed Nmax given as the sum of the rotation speed Ne of the engine 22 and the variation rate Nrt set to the smaller rate value N2 than the ordinary rate value N1 under the condition of no speed change of the transmission 60. An abruptly increasing value is accordingly not set to the target rotation speed Ne* of the engine 22. The engine 22 is controlled to increase the output torque but to restrict the increase in rotation speed. Such engine control decreases a fraction of power consumed to increase the rotation speed of the engine 22 and increases a fraction of power output to the ring gear shaft 32a, out of the whole output power of the engine 22. The speed change of the transmission 60 is performed with synchronization of the rotation speed of the motor MG2 in the decoupled state. This desirably reduces a potential torque shock occurring in the course of a speed change of the transmission 60.

As described above, at the time of a Hi-to-Lo speed change of the transmission 60 in the accelerator off state or in the low acceleration state with the driver's slight depression of the accelerator pedal 83 (in the state of driving with a low driving force), the hybrid vehicle 20 of the embodiment drives the engine 22 at the rotation speed of not lower than the speed change-time minimum rotation speed Nchg that is higher than the idling rotation speed Nidl. The engine 22 driven at the rotation speed of not lower than the speed change-time minimum rotation speed Nchg enables quicker output of a large torque and a large power, compared with the engine 22 driven at the idling rotation speed Nidl. This ensures quicker output of a large power to the ring gear shaft 32a or the driveshaft.

At the time of a Hi-to-Lo speed change of the transmission 60 in the accelerator off state or in the low acceleration state with the driver's slight depression of the accelerator pedal 83 (in the state of driving with a low driving force), the hybrid vehicle 20 of the embodiment sets the target rotation speed Ne* of the engine 22 based on the maximum rotation speed Nmax given as the sum of the rotation speed Ne of the engine 22 and the variation rate Nrt set to the smaller rate value N2 than the ordinary rate value N1 under the condition of no speed change of the transmission 60. When the driver depresses the accelerator pedal 83 to require a large torque demand Tr*, such setting controls the increase in rotation speed of the engine 22 and accordingly decreases a fraction of power consumed to increase the rotation speed of the engine 22 and increases a fraction of power output to the ring gear shaft 32a, out of the whole output power of the engine 22. This arrangement ensures a quick response to an abrupt change of the torque demand Tr* during the speed change of the transmission 60.

At the time of a Lo-to-Hi speed change of the transmission 60 in the accelerator off state or in the low acceleration state with the driver's slight depression of the accelerator pedal 83 (in the state of driving with a low driving force), the hybrid vehicle 20 of the embodiment performs the Lo-to-Hi speed change with synchronization of the rotation speed of the motor MG2 in the decoupled state. This desirably reduces a potential torque shock occurring in the course of a Lo-to-Hi speed change of the transmission 60.

At the time of a Hi-to-Lo speed change of the transmission 60 in the accelerator off state or in the low acceleration state with the driver's slight depression of the accelerator pedal 83 (in the state of driving with a low driving force), the hybrid vehicle 20 of the embodiment sets the target rotation speed Ne* of the engine 22 based on the maximum rotation speed Nmax given as the sum of the rotation speed Ne of the engine 22 and the variation rate Nrt set to the smaller rate value N2 than the ordinary rate value N1 under the condition of no speed change of the transmission 60. This is, however, not restrictive. At the time of a Hi-to-Lo speed change of the transmission 60, the target rotation speed Ne* of the engine 22 may be set based on the maximum rotation speed Nmax given as the sum of the rotation speed Ne of the engine 22 and the variation rate Nrt set to the ordinary rate value N1.

At the time of a Hi-to-Lo speed change of the transmission 60 in the accelerator off state or in the low acceleration state with the driver's slight depression of the accelerator pedal 83 (in the state of driving with a low driving force), the hybrid vehicle 20 of the embodiment drives the engine 22 at the rotation speed of not lower than the speed change-time minimum rotation speed Nchg that is higher than the idling rotation speed Nidl. In the case of prediction of a Hi-to-Lo speed change of the transmission 60 in the accelerator off state or in the low acceleration state with the driver's slight depression of the accelerator pedal 83 (in the state of driving with a low driving force), the engine 22 may be driven at a rotation speed of not lower than the speed change-time minimum rotation speed Nchg that is higher than the idling rotation speed Nidl, prior to an actual start of the Hi-to-Lo speed change.

The hybrid vehicle 20 of the embodiment is equipped with the transmission 60 having the two different speeds, the Hi gear position and the Lo gear position, to allow the speed change. The transmission 60 is, however, not restricted to this structure with two different speeds but may be designed to have three or more different speeds.

In the hybrid vehicle 20 of the embodiment, the power of the motor MG2 is converted by the transmission 60 and is output to the ring gear shaft 32a. The technique of the invention is also applicable to a hybrid vehicle 120 of a modified structure shown in FIG. 14. In the hybrid vehicle 120 of FIG. 14, the power of the motor MG2 is converted by the transmission 60 and is connected to another axle (an axle linked with wheels 39c and 39d) that is different from the axle connecting with the ring gear shaft 32a (the axle linked with the drive wheels 39a and 39b).

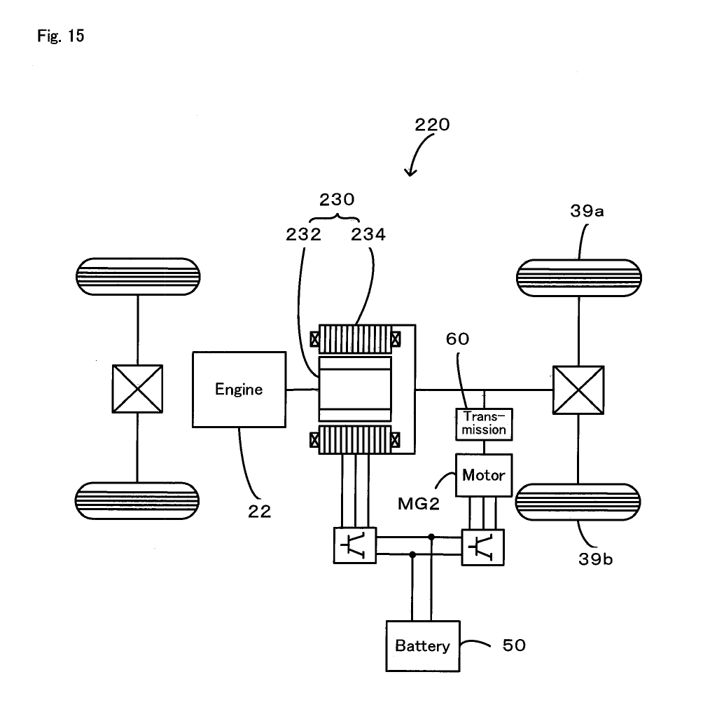

In the hybrid vehicle 20 of the embodiment, the power of the engine 22 is transmitted via the power distribution integration mechanism 30 to the ring gear shaft 32a or the driveshaft linked with the drive wheels 39a and 39b. The technique of the invention is also applicable to a hybrid vehicle 220 of another modified structure shown in FIG. 15. The hybrid vehicle 220 of FIG. 11 is equipped with a pair-rotor motor 230. The pair-rotor motor 230 includes an inner rotor 232 connected to the crankshaft 26 of the engine 22 and an outer rotor 234 connected to a driveshaft for outputting power to the drive wheels 39a and 39b. The pair-rotor motor 230 transmits part of the output power of the engine 22 to the driveshaft, while converting the residual engine output power into electric power.

The embodiment regards the hybrid vehicle 20. The principle of the present invention is, however, not restricted to the hybrid vehicle but is also actualized by diversity of other applications, for example, a driving system mounted on the vehicle in combination with an engine and a chargeable-dischargeable battery, as well as a control method of the hybrid vehicle 20 or another vehicle and a control method of the driving system.

The embodiment and its modified examples discussed above are to be considered in all aspects as illustrative and not restrictive. There may be many other modifications, changes, and alterations without departing from the scope or spirit of the main characteristics of the present invention.

### INDUSTRIAL APPLICABILITY

The technique of the present invention is preferably applied to the manufacturing industries of vehicles and driving systems.

1. A vehicle, comprising:
an internal combustion engine;
an electric power-mechanical power input output structure connected with a first axle as one of axles of the vehicle and with an output shaft of the internal combustion engine and structured to enable power input and power output from and to the first axle and the output shaft accompanied by input and output of electric power and mechanical power;
a motor configured to enable power input and power output;
a transmission connected with either the first axle or a second axle as a different axle from the first axle and with a rotating shaft of the motor and structured to transmit power between the second axle and the rotating shaft with a speed change between multiple different speeds;
an accumulator configured to transmit electric power to and from the electric power-mechanical power input output structure and the motor;
a driving force demand setter configured to set a driving force demand required for driving the vehicle; and
a controller configured to, in the case of a downshift of the speed of the transmission under the condition that the driving force demand is within a preset low driving force range including a value ‘0’, control the internal combustion engine, the electric power-mechanical power input output structure, the motor, and the transmission, so as to downshift the speed of the transmission with keeping the internal combustion engine driven at a rotation speed of not lower than a preset reference level and to drive the vehicle with a driving force equivalent to the driving force demand,
in response to an increase in driving force demand during the downshift of the speed of the transmission, the controller controlling the internal combustion engine to increase an output torque of the internal combustion engine with continuing the downshift of the speed of the transmission, while controlling the electric power-mechanical power input output structure to increase the rotation speed of the internal combustion engine with a smaller rotation speed variation per unit time, which is smaller than a variation of the rotation speed of the internal combustion engine per unit time in an ordinary state with no change of the speed of the transmission and thereby increase a power output to the first axle.

2. (canceled)

3. The vehicle in accordance with claim 1, wherein in the case of a downshift of the speed of the transmission under the condition that the driving force demand is within a preset low driving force range including a value ‘0’, the controller controls the transmission and the motor to downshift the speed of the transmission with disabling output of any torque from the motor to the second axle via the transmission, while controlling the internal combustion engine and the electric power-mechanical power input output structure to drive the vehicle with enabling output of a driving force equivalent to the driving force demand to the first axle via the electric power-mechanical power input output structure.

4. (canceled)

5. The vehicle in accordance with claim 3, wherein the transmission changes coupling and decoupling states of multiple clutches to change the speed, and
the controller controls the coupling and decoupling states of the multiple clutches to downshift the speed of the transmission via a state of decoupling the motor from the second axle.

6. The vehicle in accordance with claim 1, wherein the electric power-mechanical power input output structure includes:
a three shaft-type power input output assembly connected with three shafts, the first axle, the output shaft of the internal combustion engine, and a rotatable third shaft and designed to input and output power to a residual shaft based on powers input from and output to any two shafts among the three shafts; and
a generator configured to input and output power from and to the third shaft.

7. A driving system mounted on a vehicle, in combination with an internal combustion engine and a chargeable and dischargeable accumulator, the driving system comprising:
an electric power-mechanical power input output structure configured to transmit electric power to and from the accumulator, connected with a first axle as one of axles of the vehicle and with an output shaft of the internal combustion engine, and structured to enable power input and power output from and to the first axle and the output shaft accompanied by input and output of electric power and mechanical power;
a motor configured to transmit electric power to and from the accumulator and enable power input and power output;
a transmission connected with either the first axle or a second axle as a different axle from the first axle and with a rotating shaft of the motor and structured to transmit power between the second axle and the rotating shaft with a speed change between multiple different speeds; and
a controller configured to, in the case of a downshift of the speed of the transmission under the condition that a driving force demand required for driving the vehicle is within a preset low driving force range including a value ‘0’, control the internal combustion engine, the electric power-mechanical power input output structure, the motor, and the transmission, so as to downshift the speed of the transmission with keeping the internal combustion engine driven at a rotation speed of not lower than a preset reference level and to drive the vehicle with a driving force equivalent to the driving force demand,
immediately after an increase in driving force demand during the downshift of the speed of the transmission, the controller controlling the internal combustion engine to increase an output torque of the internal combustion engine, while controlling the electric power-mechanical power input output structure to increase the rotation speed of the internal combustion engine with a smaller rotation speed variation per unit time, which is smaller than a variation of the rotation speed of the internal combustion engine per unit time in an ordinary state with no change of the speed of the transmission, and thereby increase a power output to the first axle.

8. A control method of a vehicle, the vehicle having: an internal combustion engine; an electric power-mechanical power input output structure connected with a first axle as one of axles of the vehicle and with an output shaft of the internal combustion engine and structured to enable power input and power output from and to the first axle and the output shaft accompanied by input and output of electric power and mechanical power; a motor configured to enable power input and power output; a transmission connected with either the first axle or a second axle as a different axle from the first axle and with a rotating shaft of the motor and structured to transmit power between the second axle and the rotating shaft with a speed change between multiple different speeds; and an accumulator configured to transmit electric power to and from the electric power-mechanical power input output structure and the motor,
in the case of a downshift of the speed of the transmission under the condition that a driving force demand required for driving the vehicle is within a preset low driving force range including a value ‘0’, the control method controlling the internal combustion engine, the electric power-mechanical power input output structure, the motor, and the transmission, so as to downshift the speed of the transmission with keeping the internal combustion engine driven at a rotation speed of not lower than a preset reference level and to drive the vehicle with a driving force equivalent to the driving force demand,
immediately after an increase in driving force demand during the downshift of the speed of the transmission, the control method controlling the internal combustion engine to increase an output torque of the internal combustion engine, while controlling the electric power-mechanical power input output structure to increase the rotation speed of the internal combustion engine with a smaller rotation speed variation per unit time, which is smaller than a variation of the rotation speed of the internal combustion engine per unit time in an ordinary state with no change of the speed of the transmission, and thereby increase a power output to the first axle.

9. A control method of a driving system, the driving system being mounted on a vehicle in combination with an internal combustion engine and a chargeable and dischargeable accumulator and having: an electric power-mechanical power input output structure configured to transmit electric power to and from the accumulator, connected with a first axle as one of axles of the vehicle and with an output shaft of the internal combustion engine, and structured to enable power input and power output from and to the first axle and the output shaft accompanied by input and output of electric power and mechanical power; a motor configured to transmit electric power to and from the accumulator and enable power input and power output; and a transmission connected with either the first axle or a second axle as a different axle from the first axle and with a rotating shaft of the motor and structured to transmit power between the second axle and the rotating shaft with a speed change between multiple different speeds,
in the case of a downshift of the speed of the transmission under the condition that a driving force demand required for driving the vehicle is within a preset low driving force range including a value ‘0’, the control method controlling the internal combustion engine, the electric power-mechanical power input output structure, the motor, and the transmission, so as to downshift the speed of the transmission with keeping the internal combustion engine driven at a rotation speed of not lower than a preset reference level and to drive the vehicle with a driving force equivalent to the driving force demand,
immediately after an increase in driving force demand during the downshift of the speed of the transmission, the control method controlling the internal combustion engine to increase an output torque of the internal combustion engine, while controlling the electric power-mechanical power input output structure to increase the rotation speed of the internal combustion engine with a smaller rotation speed variation per unit time, which is smaller than a variation of the rotation speed of the internal combustion engine per unit time in an ordinary state with no change of the speed of the transmission, and thereby increase a power output to the first axle.
